(19) United States
(12) Patent Application Publication
(10) Pub. No.: US 2009/0244353 A1
(43) Pub. Date: Oct. 1, 2009

(54) IMAGE DISPLAY DEVICE, IMAGE TAKING DEVICE, AND IMAGE DISPLAY METHOD AND IMAGE DISPLAY PROGRAM

(75) Inventor: Kayo KOUTAKI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/413,731

(22) Filed: Mar. 30, 2009

(30) Foreign Application Priority Data
Mar. 31, 2008 (JP) 2008-090260
Jan. 13, 2009 (JP) 2009-004328

(51) Int. Cl. H04N 5/222

(52) U.S. Cl. 348/333.01; 348/E05.022

(57) ABSTRACT

An image display device (1) comprises a display (12) and an image recorder (8) for storing an a file (100) including a plurality of image data indicative of a subject X taken from a like number of directions, one of the plurality of image data including an management area (1012) indicating that the plurality of image data are related with each other. When a command to display the plurality of image data included in the file (100) on the display is given due to operation of a predetermined key of a key-in unit (13), the data on the like number of directions from which the plurality of image data are taken are acquired, the data being recorded in the file (100), thereby setting a display state of the display (12). Then, the plurality of image data are displayed on the display (12) in the set display state (FIG. 7).

### CROSS REFERENCE TO RELATED APPLICATIONS

This application is based upon and claims the benefit of priority from the prior Japanese Patent Application No. 2008-098260, filed Mar. 31, 2008 and Japanese Patent Application No. 2009-004328, filed Jan. 13, 2009, the entire contents of which are incorporated herein by reference.

### BACKGROUND OF THE INVENTION

1. Field of the Invention

The present invention relates to image display devices, image taking devices, image display methods, image display programs and recording mediums for a plurality of images.

2. Description of the Related Art

In the prior art, techniques are known which take a plurality of images of a subject from a like number of view angles and displays a resulting multi-view image. JP2004-139294 discloses a technique for taking a plurality of image data composing a multi-view image into a personal computer and sequentially reproducing a like number of images automatically based on information indicating directions from which the associated respective image data are taken. However, this technique involves automatically reproducing the plurality of image sequentially, irrespective of a viewer's operation. Thus, when the viewer desires to view an image of the subject taken from a desired viewing direction, he or she must wait until the target image data is reproduced.

### SUMMARY OF THE INVENTION

It is therefore an object of the present invention to allow the viewer to immediately select and view an image of a subject taken from any specified viewing angle among a plurality of images taken from a like number of view angles when he or she desires.

In order to achieve the above object, one aspect of the present invention provides an image display device comprising storage means for storing an a file including a plurality of image data of a subject taken from a like number of directions, one of the plurality of image data including information indicating that the plurality of image data are related with each other; display means; means for detecting a command to display image data included in the file on the display means; means, responsive to detecting of the command to display the image data for acquiring data on a plurality of directions from which the plurality of image data are taken, and for setting a state where the image data is displayed on the display means; and display control means for displaying the plurality of image data on the display means in the display state set by the setting means.

Another aspect of the present invention provides an image taking device comprising: means for taking a plurality of image data indicative of a subject from a like number of directions; means for acquiring data on each of the like number of directions from which an associated one of the plurality of image data is taken when the associate image data is taken; means for storing an a file including the plurality of image data indicative of a subject, each image data including data on a respective one of the like number of directions, one of the plurality of image data including information indicating that the plurality of image data are related with each other; display means; means for detecting a command to display the plurality of image data included in the file on the display means; means, responsive to detecting the command to display the plurality of image data, for acquiring data on the like number of directions from which the plurality of image data are taken, and for setting, based on the acquired data on the like number of directions, a display state where the plurality of image data are displayed on the display means; and means for displaying the plurality of image data on the display means in the display state set by the setting means.

Still another aspect of the present invention provides an image display method comprising the steps of: detecting a command to read and display a plurality of image data indicative of a subject and taken from a like number of directions from a storage device which has stored a file including the plurality of image data, one of the plurality of image data including information indicating that the plurality of image data are related with each other; responsive to detecting the command to read and display the plurality of image data, for acquiring data on the like number of directions from which the plurality of image data are taken, and setting a display state where the plurality of image data are displayed on the display means; and displaying the plurality of image data on the display means in the display state set in the setting step.

Another aspect of the present invention provides a software program product embodied in a computer readable medium for performing the method above mentioned.

### BRIEF DESCRIPTION OF THE DRAWINGS

The accompanying drawings, which are incorporated in and constitute a part of the specification, illustrate presently preferred embodiment of the present invention and, together with the general description given above and the detailed description of the preferred embodiment given below, serve to explain the principles of the present invention in which:

FIG. 1A is a front view of an image taking device according to one embodiment of the present invention.

FIG. 1B is a back view of the image taking device.

FIG. 2 is a circuit diagram of the image taking device.

FIG. 3 is a flowchart of an image taking and new-file creating process which will be performed in the embodiment.

FIG. 4A shows a file composition created in the new file creating process.

FIG. 4B shows another file composition created in the new file creating process.

FIG. 4C shows still another file composition created in the new file creating process.

FIG. 4D shows a further file composition created in the new file creating process.

FIG. 5A illustrates different directions from which a subject is viewed.

FIG. 5B illustrates a display which displays an image of the subject taken from the front.

FIG. 5C illustrates a display which displays an image of the subject taken from above.

FIG. 6A illustrates main image data indicative of a front image of the subject.

FIG. 6B illustrates sub-image data 1 indicative of a back image of the subject.

FIG. 6C illustrates sub-image data 2 indicative of a left side image of the subject.

FIG. 6D illustrates sub-image data 3 indicative of a right side image of the subject.

FIG. 6E illustrates sub-image data 4 indicative of a top image of the subject.

FIG. 6F illustrates sub-image data 5 indicative of a bottom image of the subject.

FIG. 7 is a flowchart of a sub-image data display process to be performed in the embodiment.

FIG. 8 shows a display state of the display in the embodiment.

FIG. 9 shows a sub-image read table.

FIG. 10 illustrates a storage composition of a sub-image header in a modification of the embodiment.

FIG. 11 illustrates a relationship between the subject and each of set rotational axes.

FIG. 12 is a flowchart of a display process to be performed in the modification.

FIG. 13 shows a 3D display table

FIG. 14 illustrates a display state of the display in the modification.

### DETAILED DESCRIPTION OF THE EMBODIMENTS

One embodiment of the present invention will be described with reference to the accompanying drawings.

A) Appearance Composition

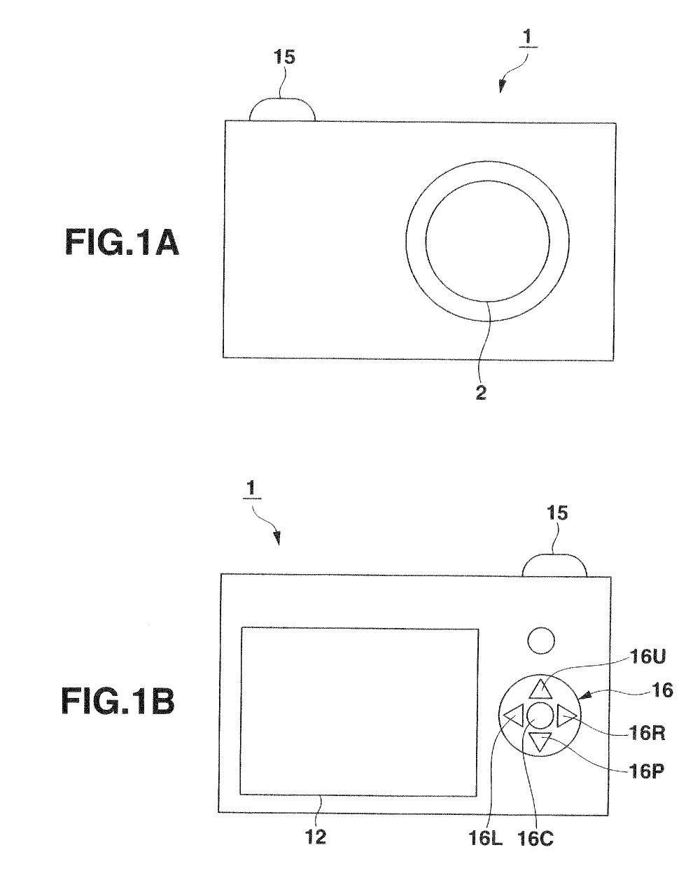

FIGS. 1A and 1B are a front and a back view, respectively, of an image taking device 1 of one embodiment of the present invention. The image taking device 1 has an image pickup lens unit 2 at a front thereof and a shutter key 15 on a top thereof. The image taking device 1 also has a display including a LCD 12 and a cursor unit 16 on a back thereof. The cursor unit 16 is composed of a center key 16C, and right left, up and down keys 16R, 16L, 6U and 16D disposed around the center key 16C.

B) Circuit Composition

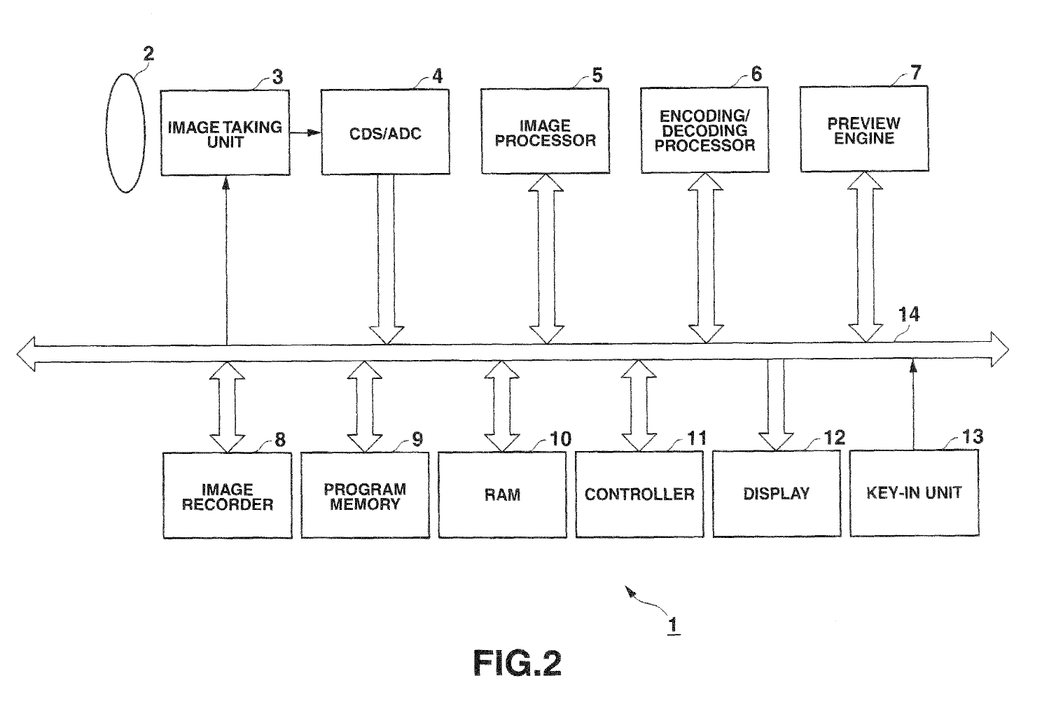

FIG. 2 is a schematic block diagram of the image taking device 1 which also functions as an image display device. The image taking device 1 includes a controller 11 connected to respective associated components of the image taking device 1 through a bus line 14. The controller 11 is in the form of a one-chip microcomputer. In FIG. 2, an image pickup lens unit 2 includes optical members.

An image pickup unit 3 is disposed on an optical axis of the image pickup lens unit 2 and composed, for example, of a CMOS image sensor. A unit circuit 4 includes a CDS which holds an analog signal representing an optical image of a subject from the image pickup unit 3, an automatic gain control (AGC) which amplifies the analog signal appropriately, and an A/D converter (ADC) which converts the amplified signal from the AGC to a digital image signal.

An image processor 5 processes the respective digital signals from the unit circuit 4. Then, a preview engine 7 appropriately decimates the signal from the image processor 5 and provides a resulting signal to the display 12.

Then, the display 12 receives the digital image signal from the preview engine 7 and a drive control signal which drives a driver thereof, and then displays an image based on the digital signal as a through image on a lower layer.

In image recording, the signal processed by the image processor 5 is compressed, encoded, and formed as a file of a type to be described later, and then this file is recorded on an image recorder 8. In image reproduction, main and sub-image data included in the file and read from the image recorder 8 are decoded by the encoding/decoding processor 6 and then displayed on the display 12.

In addition to the production of the through image, the preview engine 7 performs control operations required for displaying an image on the display 12 immediately before the image is recorded in the image recorder. The key-in unit 13 is composed of the shutter key 15, the cursor unit 16 which is composed of the right, left, upper and lower keys 16R, 16L, 16U and 16D, and other keys (not shown).

The bus line 14 is also connected to a RAM 10 which temporality stores working data and resulting intermediate files, and a program memory 9, which has stored programs for performing processings indicated in flowcharts to be described later in more detail.

C) Image Taking and New File-Creating Processes

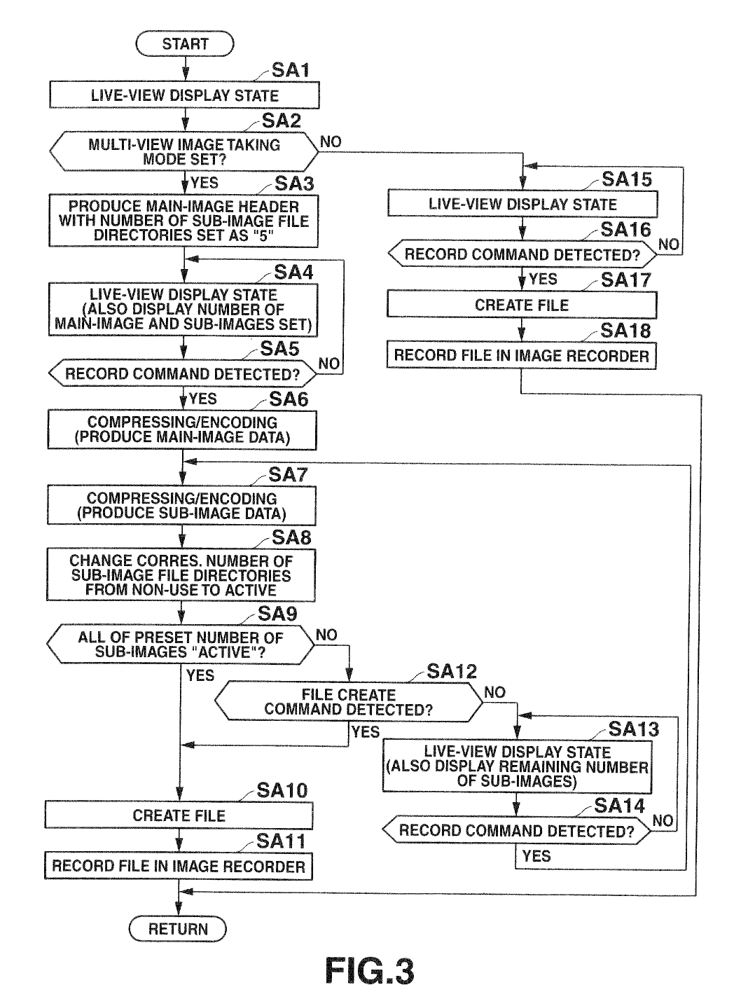

Then, a process which involves an image taking process to be performed in the image taking device 1 through a file creating process will be described. FIG. 3 is a flowchart covering an image taking process to be performed by the image taking device 1 through a recording process to be performed by an image recorder 8. When commanded to start up an image taking mode by operation of a predetermined key at the key-in unit 13, the controller 11 reads and executes a program involving an image taking process from the program memory 9, and then causes the image taking device 3, unit circuit 5, image processor 5, RAM 10, encoding/decoding processor 6 and preview engine 7 to perform their respective initial operations (starting state).

The unit circuit 4 periodically converts an image focused on the image taking unit 3 through the image taking lens unit 2 to a digital image signal. The image signal processor 5 processes the digital image signal and displays a resulting image on the display 12 in a live view state (step SA1). In this live-view display state, the controller 11 determines if a multi-view image taking mode is set by operating a predetermined key at the key-in unit 13 (step SA2).

If not (No in step SA2), the controller 11 returns to the live-view display state (step SA15), and then waits for a command to record the image focused on the image taking device 3 (step SA16). When receiving the command (Yes in step SA16), the controller 11 temporarily stores on the RAM 10 image data corresponding to the focused image, and then the encoding/decoding processor 6 creates a file of a type conforming to the DCF standard (Exif format) under control of the controller 11 (step SA17).

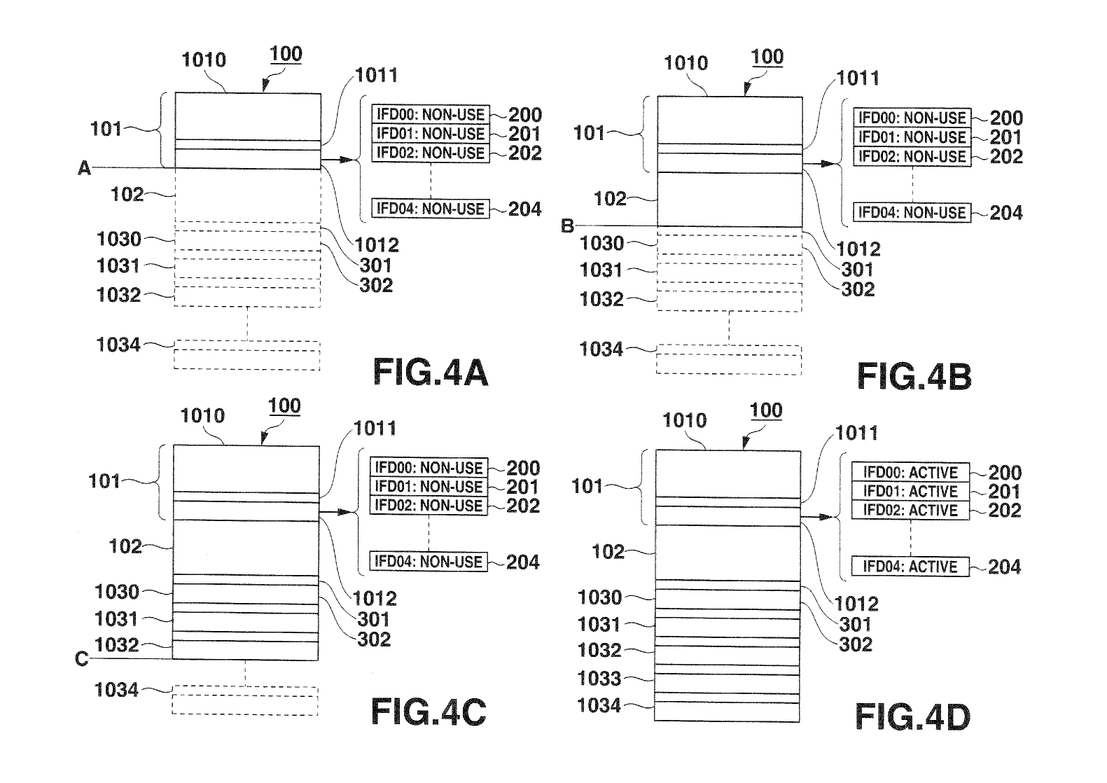

The controller 11 then records the created file to the image recorder 8 (step SA18) and then returns to the live-view display state. When the controller 11 detects and shows that the multi-view image taking mode is set (Yes in step SA2), the user inputs the number of sub-images or their file directories to be produced, thereby causing the controller 11 to produce corresponding file directories, for example IFD00-IFD04 with a state “Non-use”, in a main image header 101, as shown in FIG. 4A (step SA3). Then, the set number of main-image and sub-images is displayed along with an image displayed in a live-view display state (step SA4). Detailed description including the file production will be given later with reference to FIG. 4A-4D.

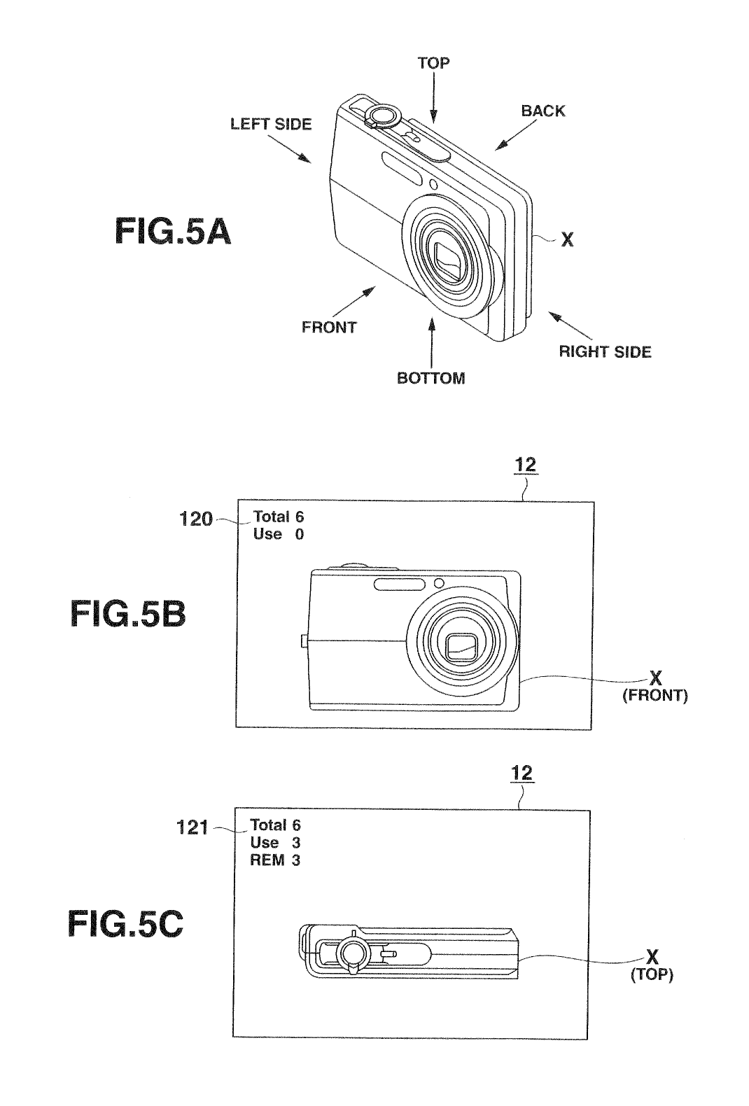

FIG. 5B shows a display state of the display 12 when an image of a subject X, which includes a digital camera of FIG. 5A, is taken from the front. In FIG. 5B, the display 12 displays a front image of the subject X along with states “Total 6” and “Use 0” set in an information display area 120, where the former indicates that the set total number of a main-image and sub-images or data, or the number of sub-image file directories, is “5” and that the latter indicates that the number of the main-image and sub-images or their data, or the recorded number of sub-image file directories, is “0”.

In this live-view display state, the controller 11 waits for a command to record an image focused on the image taking device 3 (step SA5). When detecting this command (Yes in step SA5), the controller 11 temporarily stores on the RAM 10 image data indicative of the focused image. Then, the encoding/decoding processor 6 performs a compressing/encoding process on the image data, thereby producing main image data, under control of the controller 11 (step SA6). That is, by taking an image of the subject X from the front, its main image data is produced.

Then, the encoding/decoding processor 6 performs the compressing/encoding process on an image focused on the image taking device 3 or image data stored temporarily on the RAM 10 to produce sub-image data the number of which is equal to the number of sub-images preset by the operator's operation different from the above sub-image setting operation, or by the image taking program stored in the program memory 9 (step SA7).

The operator's operation different from the above sub-image setting operation is, for example, as follows:
(1) When an image of the back of the subject X is taken, the shutter key 15 is depressed while the center key 16C is being depressed:
(2) When an image of the left side of the subject X is taken, the shutter key 15 is depressed while the left key 16L is being depressed:
(3) When an image of the right side of the subject X is taken, the shutter key 15 is depressed while the right key 16R is being depressed:
(4) When an image of the top of the subject X is taken, the shutter key 15 is depressed while the up key 16U is being depressed: and
(5) When an image of the bottom of the subject X is taken, the shutter key 15 is depressed while the down key 16L is being depressed:

The image taking programs stored in the program memory 9 include a program which successively takes a predetermined number of images automatically, and a program which takes images by automatically selecting image taking conditions such as exposure value, shutter speed and white balance.

The process for producing sub-image data from the image data stored temporarily on the RAM 10, for example, includes creating image data different in resolution, storage size or compression ratio from the image data stored temporarily on the RAM 10.

When the sub-image data have been produced and recorded along with the main image in the image recorder 8, the controller 11 changes the state “Non-use” of corresponding ones of the sub-image file directories set in the main image header in the step SA3 to “Active” (meaning “recorded”) and then annexes a SOI (Start of Image) marker to each of the heads of the sub-image data (step SA8).

Then, the controller 11 determines if sub-images the number of which is equal to the number of sub-images preset in the step SA3 have been recorded, or if the state of all the sub-image file directories has changed from “Non-use” to “Active” (step SA9). If so (Yes in step SA9), the controller 11 creates a file including the main image header, the main image data and the sub-image data (step SA10), records the created file into the image recorder 8 (step SA11) and then returns to the live-view display state.

When determining that all the sub-image file directories are not “Active” (No in step SA9), the controller 11 waits for a file create command to be issued due to depression of an associated key at the key-in unit 13 without creating the file immediately (step SA12). When detecting this command (Yes in step SA12), the controller 11 forms the file in step SA10.

If not (No in step SA12), the controller 11 then displays the set number of sub-images, the recorded number of sub-images and the remaining number of sub-images to be further recordable and displayed as “None-use”, along with an image on the display 12 in a live-view display state (step SA13).

FIG. 5C illustrates a display state in the step SA13. In FIG. 5C, the display 12 displays the image of the subject X, “Total 6” indicating that the total number of a main-image and sub-images or their data, or sub-image file directories, set in the information display area 121 is 6, “Use 3” indicating that the recorded number of images (main-image and two sub-images, or sub-image file directories, is 2), and “REM 3” indicating that the remaining number of sub-images, or sub-image file directories, to be recordable is 3.

The controller 11 then waits for a record command in the live-view display state (step SA14). When detecting the record command (Yes in step SA14), the controller 11 returns to step SA7 and the encoding/decoding processor 6 performs the compressing/encoding process on the image data stored temporarily in the RAM 10, thereby forming the preset number of sub-image data.

Referring to FIG. 4A-4D, a process for producing a file 100 in the flowchart of FIG. 3 will be described. The file 100 to be produced has a format conforming to the DCF standard (for Exif format) excluding the following points:

A plurality of image data associated with each other are stored; and

A plurality of management areas which manage respective ones of the associated plurality of image data are set in the header of any one of the plurality of image files. In the embodiment, the main image includes image data which in turn includes the management area, and the sub-image data includes image data associated with the main image data. Each file 100 is composed of a main image header 101, a main image data setting area 102, and a plurality of sub-image data setting areas 1030, 1031, 1032, 1033 and 1034.

The main image header 101 includes:
A basic information setting area 1010 where a tag indispensable for Exif is set;
A thumbnail image data setting area 1011 where thumbnail image data of the main image data is set; and,
A management area 1012 including information for managing the number of sub-image data and sub-image index file directory tags and for setting and managing sub-image file directories 200-204.

The sub-image file directories 200-204 store a sub-image type, a sub-image data offset, an individual sub-image number, a dependent sub-image file directory, and an offset of a next sub-image file directory, respectively.

The main image data is written into the main image data setting area 102. Each of the sub-image data setting areas 1030-1034 includes a sub-image header 301 where thumbnail image data, attribute information and a tag indispensable for Exif of the sub-image data alone are set, and a sub-image data setting area 302. Since the thumbnail image data is set in the sub-image header 301, the sub-image data itself is larger in size than the thumbnail image data (120 vertical×160 horizontal).

FIG. 4A shows the processing in the step SA3 of the FIG. 3 flowchart. When the number of sub-images is set in the step SA3, a like number of sub-image file directories are set in the management area 1012. Thus, for example, five such areas IFD00-IFD04, designated by 200-204, respectively, are set with each having a state “Non-use”.

A setting area present above a line A where the main image header 101 including the management area 1012 is set is secured. A file composition (shown in FIG. 4D) where a maximum of 6 sub-image data are produced is decided temporarily.

FIG. 4B shows the processing in the step SA6 of the FIG. 3 flowchart. When main image data is produced in the step SA6, its thumbnail data is written to the thumbnail image data setting area 1011, and the main image data is written to the main image data setting area 102. Thus, a part of the file area present above a line B is secured.

FIG. 4C shows the processing in the step SA7 of the FIG. 3 flowchart. When, for example, three sub-image data are produced in the step SA7, each of these data is written to a sub-area 302 of a respective one of three sub-image data setting areas 1030-1032 with associated thumbnail image data written in a sub-image header 301 of that sub-image data setting area. Thus, the file area present above a line C is secured.

FIG. 4D shows the processing in the step SA8 of the FIG. 3 flowchart. When the sub-image data is written in the step SA7, the file composition including the main and sub-image data present above a solid line C in FIG. 4C is fixed at that time. Thus, the state “Non-use” of each of the sub-image file directories IFD00-IFD02 is changed to “Active” and an SOI marker is added to each of the sub-image data.

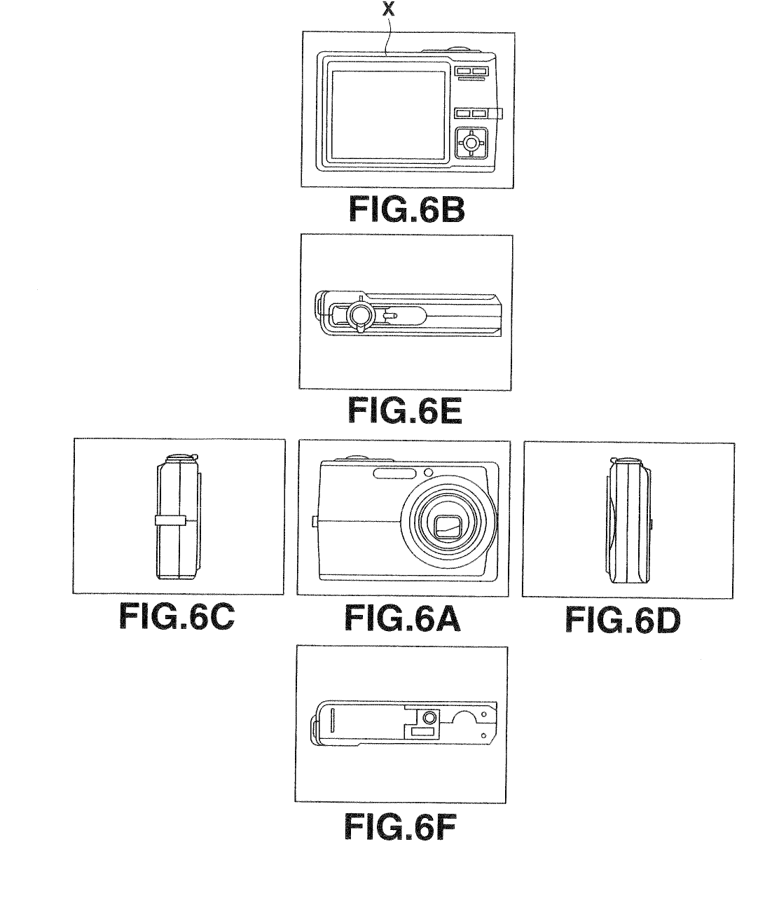

Then, the file is produced, including a whole area covered with solid lines in FIG. 4D in the step SA10 of the FIG. 3 flowchart, and then recorded to the image recorder 8. Thus, the file includes main image data for the front of the subject X of FIG. 6A, and 5 sub-image data 1-5 involving the back, left-side, right-side, top and bottom of the subject shown in FIGS. 6B-F, respectively.

According to this flowchart, when the image taking device produces a file including sub-image data, setting the number of sub-image data beforehand advantageously reduces a load which would otherwise be required for composing the file thereafter. Further, when the number of sub-image data recorded in the image taking process falls short of a preset number, new sub-images can continue to be recorded, advantageously. In addition, the preset number of sub-image data, the recorded number of sub-image data, and the number of sub-image data to be recordable newly are displayed in the live-view display state. The operator can easily understand “How many more sub-images can be recorded?”. Further, even when all of the preset number of sub-images are not recorded, the process up to the file production can be easily be terminated, advantageously.

D) Image Data Display Process:

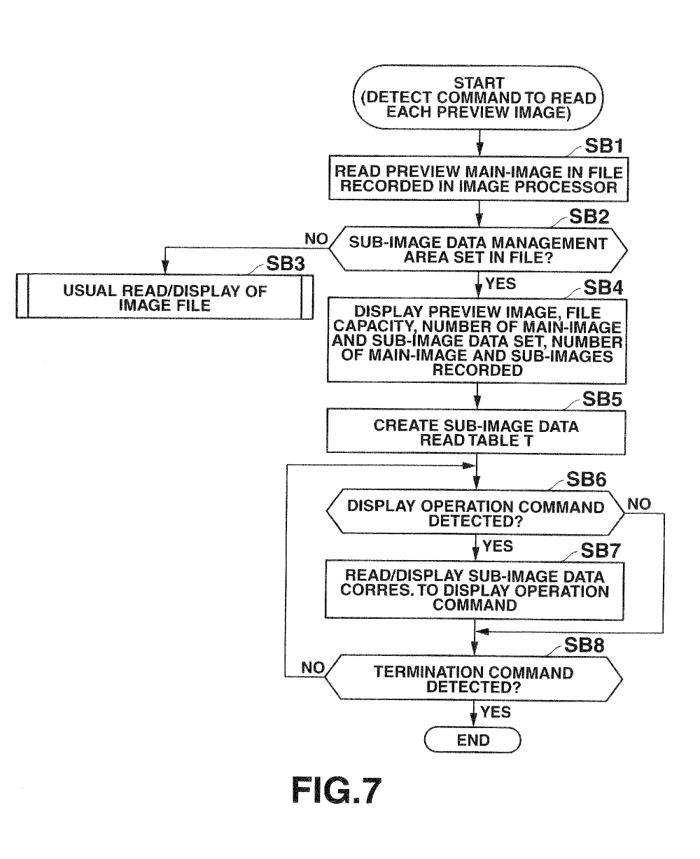

Then, an image data display process to be performed by the image taking device 1 will be described. FIG. 7 is a flowchart of the image data display process. In FIG. 7, the image taking device 1 operates in a reproduction mode. In the flowchart, it is assumed that a predetermined operation performed at the key-in unit 13 is detected and that reading and display of a (preview) image stored in each of the files recorded in the image recorder 8 is commanded.

In response to this command, the controller 11 reads main image data from that file (step SB1), and then determines if a management area 1012 is set in the main image header 101 of the read image file (step SB2).

If not (No in step SB2), the controller 11 goes to usual reading/display of the image file (step SB3). When determining that the management area 1012 is set (Yes in step SB2), the controller 11 determines that the file includes main and sub-image data therein. Then, the controller 11 resamples that main image data to a resolution which the display 12 requires, thereby producing and displaying a preview image on the display 12.

Besides, the controller 11 reads information recorded in the main and sub-image headers 101 and 301 and information set in the sub-image file directories of the management area 1012 and then displays the capacity of that file, the set number of sub-image data, and the recorded number of sub-image data (step SB4).

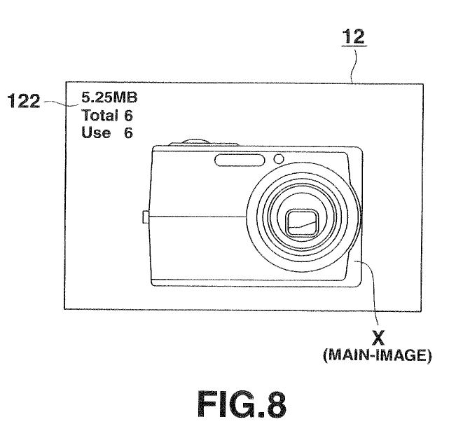

FIG. 8 shows a display state of the display 12 at this time. In FIG. 8, the main or front image of the subject X, the capacity of the file (5.25 MB), the set total number of a main-image and sub-images or data (“Total 6”), and the recorded number of the main-image and sub-images or data (“Use 6”) are displayed in the information display area 122 of the display 12.

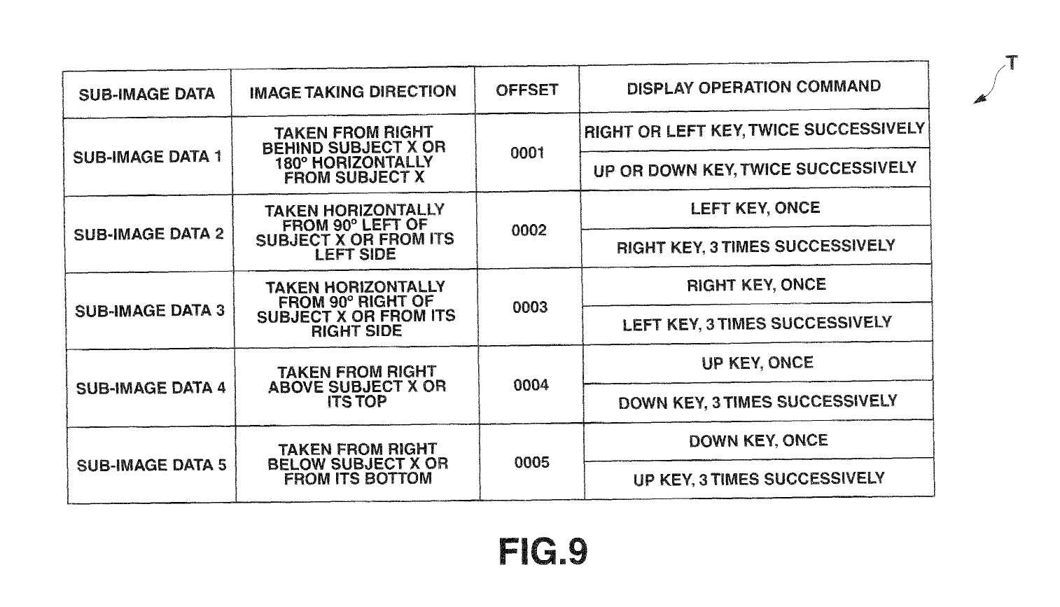

Then, in this state a sub-image read table T is created in the RAM 11 (step SB5). FIG. 9 shows the sub-image read table T. As shown, the a table T has 5 sub-image data each with “image taking direction”, “offset” and “display operation command” columns. Each “image taking direction” indicates a direction from which associated sub-image data is taken. For example, sub-image data 1 is taken from the back of the subject X (or from a direction rotated 180° horizontally from its front in to FIG. 5A. Sub-image data 2 is taken from the left side of the subject X (or from a direction rotated 90° left horizontally from the front of the subject). Sub-image data 3 is taken from the right side of the subject X (or from a direction rotated 90° right horizontally from the front of the subject). Sub-image data 4 is taken from right above the subject X (or from a direction rotated 90° upward from the front of the subject). Sub-image data 5 is taken from right below the subject X (or from a direction rotated 90° downward from the front of the subject).

Each “offset” indicates an address in the image file where the associated sub-image data is stored. The “display operation command” indicates that a selected one of the right, left, up and down keys 16R, 16L, 16U and 16D should be operated to read and display associated sub-image data stored in the image file. For example, if the user operates one of the right, left up and down keys 16R, 16L, 16U and 16D twice successively, the sub-image 1 indicative of the back side of the subject is displayed. If the user operates either the left key 16L once or the right key 16R three times successively, the sub-image data 2 indicative of the left side of the subject is displayed.

In step SB5 of the FIG. 7 flowchart, the controller 11 determines if any operation command on the sub-image read table T is detected. If so, the controller 11 reads sub-image data corresponding to the detected display operation command from an address indicated by a corresponding “Offset” and then displays it on the display 12 (step SB7).

Then, the controller 11 determines based on an input from the key-in unit 13 if the termination of this process is commanded (step SB8). If not (No in step SB8), the controller 11 goes to the step SB6. If so (Yes in step SB8), the controller 11 terminates this process.

Thus, until the termination of this process is commanded, a loop including the steps SB6-SB8 is repeated and each time a display operation command is detected during this lopping operation (Yes in step SB6), the controller 11 reads sub-image data corresponding to the detected display operation command from an address indicated by an associated “Offset” and then displays it on the display 12 (step SB7), as described more specifically as follows:

(1) When the left, right, up or down key 16L, 16R, 16U or 16D is operated twice successively, the sub-image data 1 is read, thereby displaying the back image of the subject shown in FIG. 6B.

(2) When the left key 16L is operated once or when the right key 16R is operated three times successively, the sub-image data 2 is read, thereby displaying a left side image of the subject shown in FIG. 6C.

(3) When the right, key 16R is operated once or when the left key 16L is operated three times successively, the sub-image data 3 is read, thereby displaying a right side image of the subject shown in FIG. 6D.

(4) When the up key 16U is operated once or when the down key 16D is operated three times successively, the sub-image data 4 is read, thereby displaying a plan image of the subject shown in FIG. 6E.

(5) When the down key 16D is operated once or when the up key 16U is operated three times successively the sub-image data 5 is read, thereby displaying a bottom image of the subject shown in FIG. 6F.

As described above, the sub-image table T is created and a display state of a sub-image is determined based on the content of the table T. Thus, the sub-image is rapidly displayed.

Since the main image is first displayed and then the sub-image is displayed depending on its associated key operation, the user can view the main image to thereby determine a sub-image in a direction from which the user wishes to view. Thus, the user can immediately display his or her desired image when he or she desires.

E) Modification

In the above embodiment, the user can display his or her desired image immediately when he or she desires. However, it is difficult to ascertain at a glance a positional relationship between a directing in which a desired image of the subject is taken and a direction from which sub-image data associated with another image of the subject is taken.

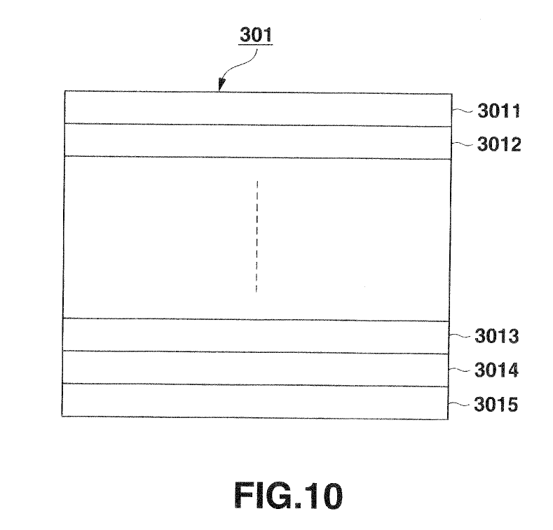

The modification eliminates this problem and will be described next in detail. Referring now to the modification of FIG. 10, the same reference numerals are used for the same components, functions and steps as in FIG. 4A-4D for convenience and new reference numerals are to employed for the new components, functions and steps used in an analogous way.

FIG. 10 illustrates data stored in a sub-image header 301 of the modification. FIG. 10 is the same as the FIG. 4, excluding that the sub-image header 301 includes a storage area 3011 storing versions of the file format; and a storage area 3012 storing sub-image data offsets, individual sub-image numbers, dependent sub-image file directories and offsets of next sub-image file directories such as those in the sub-image file directories IFDs 202-204.

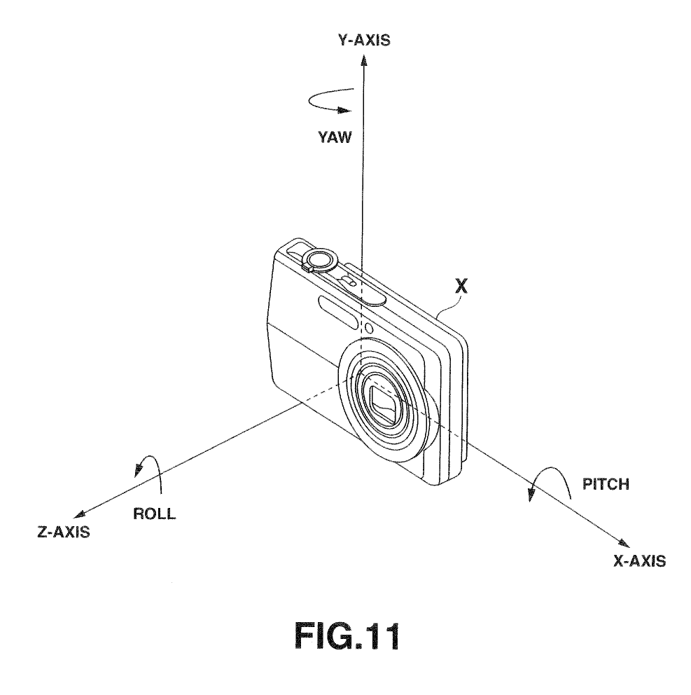

The sub-image header 301 also includes a storage area 3013 which stores a yaw rotational angle around a Y-axis, a storage area 3014 which stores a pitch rotational angle around an X-axis, and a storage area 3015 which stores a roll rotational angle around a Z-axis, defining the viewing directions in which an image of the subject X is taken, as shown in FIG. 11.

The respective rotational angles are stored in the storage areas 3013-3015 when the user's following steps in the image taking operation are detected:

(1) When the shutter key 15 is depressed while the center key 16C is being depressed, the controller 11 determines that the back image of the subject X should be taken and then stores “0”, “∓180”, and “∓180” (or “∓180”, “0” and “0”) in the storage areas 3013, 3014 and 3015, respectively.

(2) When the shutter key 15 is depressed while the left key 16L is being depressed, the controller 11 determines that a left side image of the subject X should be taken and then stores “90”, “0”, and “0” in the storage areas 3013, 3014 and 3015, respectively.

(3) When the shutter key 15 is depressed while the right key 16R is being depressed, the controller 11 determines that the right side image of the subject X should be taken and then stores “−90”, “0”, and “0” in the storage areas 3013, 3014 and 3015, respectively; and

(4) When the shutter key 15 is depressed while the up key 16U is being depressed, the controller 11 determines that a top image of the subject X should be taken and then stores “0”, “90”, “0” in the storage areas 3013, 3014 and 3015, respectively;

(5) When the shutter key 15 is depressed while the down key 16D is being depressed, the controller 11 determines that a bottom image of the subject X is taken and then stores “0”, “−90”, and “0” in the storage areas 3013, 3014 and 3015, respectively.

It is noted that the method of storing the rotational angles in the image taking process is not limited to the examples mentioned above. For example, a detector which detects the image taking direction such as an azimuth sensor, a gyro sensor or an acceleration sensor may be provided in the image taking device 1 to detect and store a direction from which an image of the subject is taken.

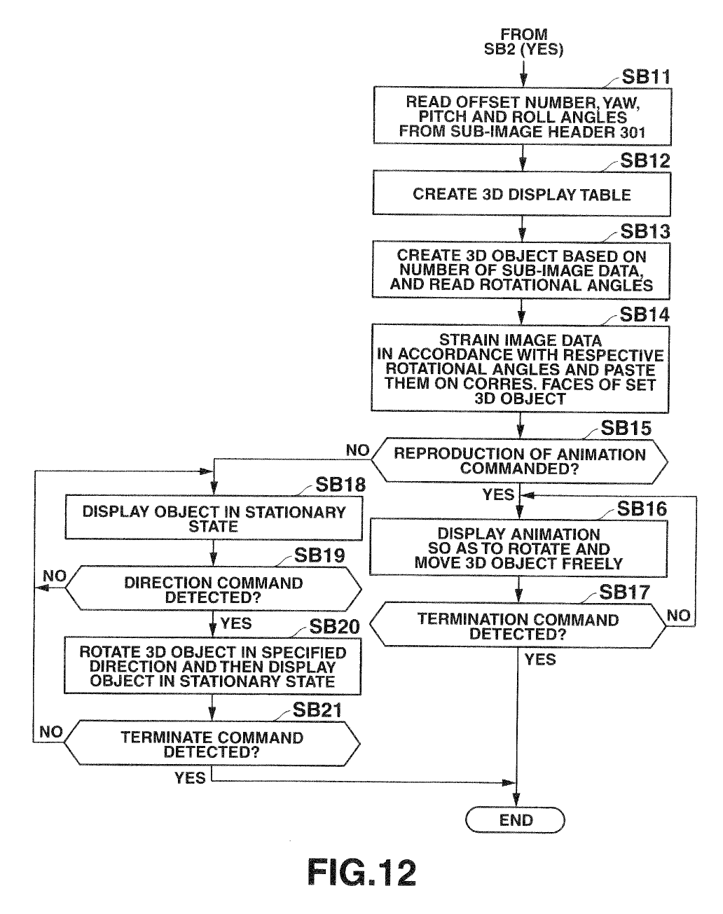

A display process for displaying an image data in the image taking device 1 will he described. FIG. 12 is a flowchart of a display process portion continued to a step SB2 of FIG. 7. When determining that in the step SB2 a management area 1012 is set (Yes in step SB2), the controller 11 determines that this file includes main and sub-image data.

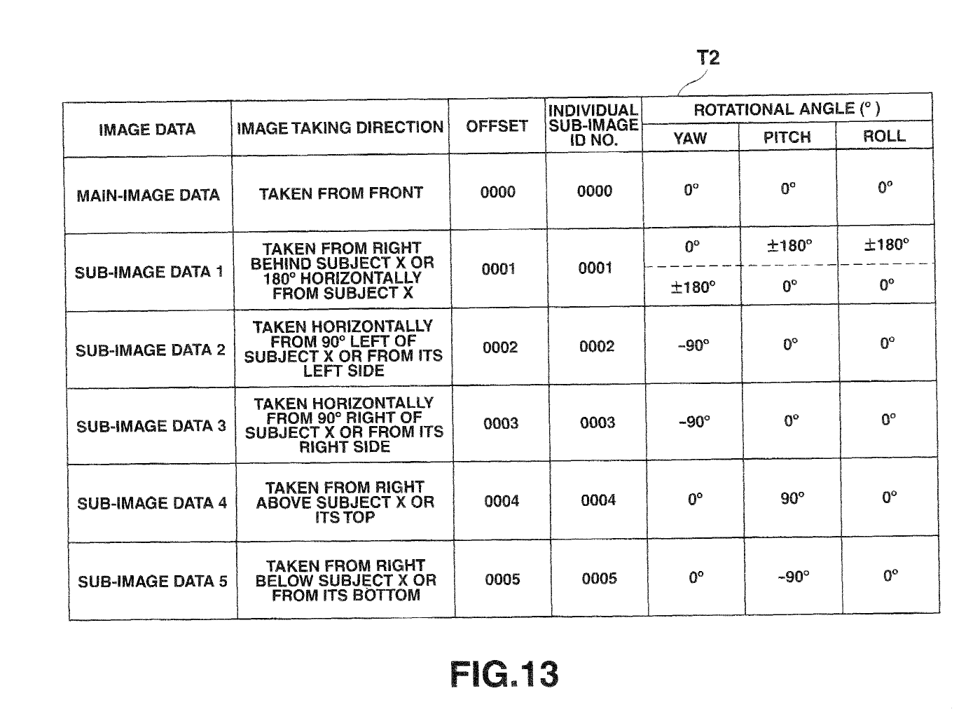

Then, the controller 11 reads offset numbers and individual sub-image numbers stored in the storage area 3012 of the sub-image header 301; and yaw, pitch and roll rotational angles stored in the storage areas 3013-3015, respectively (step SB11), thereby producing a three-dimensional display table T2 of FIG. 13 (step SB12).

As shown in FIG. 13, the table T2 includes “image data”, “image taking direction”, “offset”, “individual sub-image number” and “rotational angle” columns. The image data column includes main image data and 6 sub-image data 1-5. The “image taking direction” and “offset” columns are similar to those corresponding ones of the table T of FIG. 9. The table T2 is different from the table T in that the former table includes the “individual sub-image number (ID)” and “rotational angle” columns, instead of the display operation command column. The data stored in these columns are read in the step SB11. The main image data is obtained from the front of the subject X when the respective yaw, pitch and roll rotational angles are “0”.

When the 3D display table T2 is produced, a 3D object to be displayed is produced in accordance with the sub-image data and associated image taking directions (or the yaw, pitch and roll rotational angles) (step SB13).

The production of this 3D object will be described more specifically. In this modification, six images of the subject X: that is, front, back, right side, left side, top and bottom images are taken. Thus, a cube object is produced. According to the above method, when a 3D display table T2 is produced, including an image of the subject X taken from the front of the subject X, an image of the subject taken at a yaw angle of 120° where the pitch and roll angles are 0°, an image of the subject taken at a yaw angle of −120° where the pitch and roll angles are 0°, and a bottom image of the subject taken from the back, a regular tetrahedron object is produced.

In the production of the 3D object, all image data equal in number to the faces of the 3D object are not required. In short, data on the image taking directions are required to be stored beforehand in the sub-image header 301.

When the 3D object is produced in the step SB13, a display state is set where texture data including the main and sub-image data set on the table T2 are pasted on the respective corresponding faces of the 3D object in accordance with their respective rotational angles (step SB14). Then, the controller 11 determines if reproduction of an animation of the 3D object is beforehand commanded (step SB15).

The determination in the step SB15 may be performed in accordance with flag information set in the controller 11, or otherwise may be performed by reading a reproduction method stored as command information in a file including the main and sub-image data.

If determining that reproduction of an animation of a 3D object is commanded (Yes in step SB15), the controller 11 reproduces and displays such animation which rotates and moves freely (step SB16).

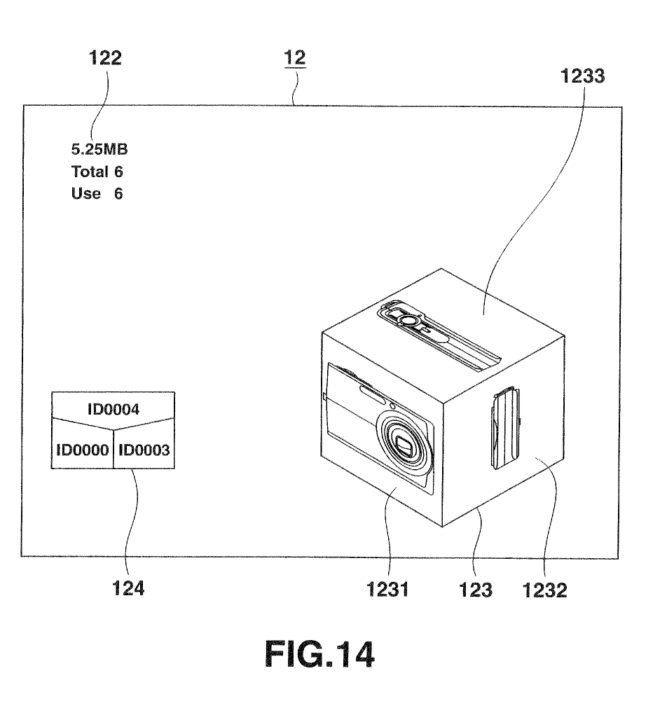

One display state of the 3D object animation in this case is shown in FIG. 14. That is, the display 12 displays a 3D object 123 on which image data 1231-1233 are pasted as texture data (in fact, it is assumed that the animation has been reproduced). The image data 1231-1233 are obtained by changing main image data taken from the front of the subject, right side sub-image data taken from the right side of the subject, and top sub-image data taken from the top of the subject so as to be distorted based on a direction of displaying or viewing the 3D object 123.

In FIG. 14, an information display area 122 and a mapping data area 124 are displayed. The mapping data area 124 indicates individual sub-image ID numbers of main and sub-image data corresponding to texture data pasted on the faces of the 3D object displayed at present. Thus, we can see a positional relationship between image data displayed at present based on the image data taking directions.

While the animation of the 3D object is being reproduced, the controller 11 determines if a command to operate a predetermined key at the key-in unit 13 or otherwise a sign in the internal processing, for example, indicative of elapse of a predetermined time from the start of the animation reproduction has been detected, thereby determining if a command to terminate the animation reproduction is detected (step SB17). If not (No in step SB17), the controller 11 continues to perform the processing in the step SB16. If detecting that command (Yes in step SB17), the controller 11 terminates the flowchart.

If determining that the controller 11 is not commanded to reproduce the 3D object animation (No in step SB15), the controller 11 displays a stationary 3D object on the display 12 (step SB18). In this case, the 3D object is displayed in a manner similar to that in the step SB16, but no animation reproduction is performed.

Then, the controller 11 determines if an image taking direction is specified by depression of any of the up, down, right and left direction keys of the cursor key unit 16 (step SB19). If not (No in step SB19), the controller 11 keeps the stationary state of the 3D object in the step SB18. When detecting that the image taking direction is specified (Yes in step SB19), the controller 11 rotates the 3D object in the specified direction and then displays the 3D object in a stationary state (step SB20).

During this time, the controller 11 determines if operation of a predetermined key at the key-in unit 13 or a sign indicative of elapse of a predetermined time since the start of the animation reproduction, or a sign indicative of the termination of the animation reproduction has been detected, thereby detecting if the termination of the animation reproduction is commanded (step SB21). If not (No in step SB21), the controller 11 continues to perform the processing at the step SB20. If detecting that the termination of the animation reproduction is commanded (Yes in step SB21), the controller 11 terminates the processing in the flowchart.

According to this modification, the user can easily display an image of the subject taken from a desired direction from among a plurality of images of the same subject taken from a like number of directions, and easily understand a positional relationship between images based on their image taking directions.

While in the present embodiment the number of sub-images to be recorded in the image file is illustrated as 5, it is not limited to this particular number. It may be more or less than 5.

When it is desired to increase the number of sub-images to be taken, images taken from obliquely above and below the subject are preferably added.

While in the embodiment image display in the image taking device has been described, the present invention is applicable to devices, methods and programs capable of displaying a plurality of images.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An image display device comprising:
storage means for storing an a file including a plurality of image data of a subject taken from a like number of directions, one of the plurality of image data including information indicating that the plurality of image data are related with each other;
display means;
means for detecting a command to display image data included in the file on the display means;
means, responsive to detecting of the command to display the image data for acquiring data on a plurality of directions from which the plurality of image data are taken, and for setting a state where the image data is displayed on the display means; and
display control means for displaying the plurality of image data on the display means in the display state set by the setting means.

2. The image display device of claim 1, further comprising:
means for detecting a direction of viewing the subject; and
wherein:
in the display state set by the setting means, the display control means reads and displays from the file image data of the image taken from a direction coinciding with the direction of viewing the subject.

3. The image display device of claim 1, wherein the setting means comprises means for producing a three-dimensional display object with a plurality of faces perpendicular to the direction of viewing the first-mentioned subject; and wherein:
the display state, each of the plurality of image data is displayed as texture on a respective one of the plurality of faces of the three-dimensional display object produced by the producing means.

4. The image display device of claim 3, wherein in the display state, the three-dimensional display object is rotated in accordance with information indicative of a rotational angle of a rotational axis of the object coinciding with a direction from which an associated image of the subject is taken thereby displaying a moving image of the object.

5. The image display device of claim 1, further comprising:
means for taking an image of the subject;
means for acquiring data on a direction from which the associated image is taken by the image taking means; and
means for storing in the storage means image data of the subject taken by the image taking means, the image data including the data on a direction acquired by the acquiring means.

6. The image display device of claim 1, wherein the storage means stores the information indicating that the plurality of image data are related with each other and included in header information of any one of the plurality of image data.

7. An image taking device comprising:
means for taking a plurality of image data indicative of a subject from a like number of directions;
means for acquiring data on each of the like number of directions from which an associated one of the plurality of image data is taken when the associate image data is taken;
means for storing an a file including the plurality of image data indicative of a subject, each image data including data on a respective one of the like number of directions, one of the plurality of image data including information indicating that the plurality of image data are related with each other;
display means;
means for detecting a command to display the plurality of image data included in the file on the display means;
means, responsive lo detecting the command to display the plurality of image data, for acquiring data on the like number of directions from which the plurality of image data are taken, and for setting, based on the acquired data on the like number of directions, a display state where the plurality of image data are displayed on the display means; and
means for displaying the plurality of image data on the display means in the display state set by the setting means.

8. An image display method comprising the steps of:
detecting a command to read and display a plurality of image data indicative of a subject and taken from a like number of directions from a storage device which has stored a file including the plurality of image data, one of the plurality of image data including information indicating that the plurality of image data are related with each other;
responsive to detecting the command to read and display the plurality of image data, for acquiring data on the like number of directions from which the plurality of image data are taken, and setting a display state where the plurality of image data are displayed on the display means; and
displaying the plurality of image data on the display means in the display state set in the setting step.

9. A software program product embodied in a computer readable medium for performing the method of claim 7.
